(19) United States
(12) Patent Application Publication
(10) Pub. No.: US 2010/0042740 A1
(43) Pub. Date: Feb. 18, 2010

(54) METHOD AND DEVICE FOR DATA PACKING

(75) Inventor: Puranjoy Bhattacharya, Bangalore (IN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/306,561

(22) PCT Filed: Jun. 15, 2007
(86) PCT No.: PCT/IB2007/052295

§ 371 Date: Sep. 30, 2009

(30) Foreign Application Priority Data
Jun. 26, 2006 (EP) 06116074.3

(51) Int. Cl. G06F 15/16

(52) U.S. Cl. 709/231; 709/233

(57) ABSTRACT

A method and a device is presented for communicating a first data stream encoded according to a non-PCM format through a communication link that is designed communicating a data stream encoded according to a PCM format. The method and device receive a first data stream encoded according to a non-PCM format. The received data stream comprises a plurality of data-packets. The method and device pack the first data stream into a second data stream. The second data stream has plurality of data-packets. Each of the data-packets of the second data stream includes a discontinuity according to the PCM format. The second data stream is communicated through the link. A method and a device are further provided for receiving the second data stream via the link and for identifying the format of the received data stream by examining for the discontinuity.

The present invention relates to a method and a device for data packing, and more specifically to a method and a device for packing a data stream encoded according to a non-PCM (Pulse Coded Modulation) format for communicating it through a communication link designed to communicate a data stream encoded according to a PCM format.

Definition 1: The wording—a communication link “designed for” communicating a data stream encoded according to a PCM format—is defined as a communication link that receives a data stream encoded according to the PCM format from a first unit and facilitates its communication to a second unit.

Definition 2: In this document the word “header” includes a set of “preamble words”. Preamble words may be “sync-words” and/or words that contain metadata specific to a data stream.

Definition 3: For the sake of brevity, simplicity, clarity and exemplification, hereinafter, an I2S link will represent a class of communication links designed for communicating data encoded according to a PCM format. A data encoded according to an AC3 data format represents a data encoded according to a non-PCM format. However, a person skilled in the art will appreciate that the present invention is also applicable to data communication links other than I2S link, designed for communicating data encoded according to the PCM format. Further, the person will also appreciate that the present invention is equally applicable to the non-PCM data formats other than the AC3 data format.

A Pulse Code Modulated (PCM) format is a basic form of coding a digital audio signal. Data encoded according to the PCM format has a known word length and a known sample frequency. Data communication links (such as an I2S link) are used for communicating the PCM-encoded digital audio signals between devices/processors. With advancement in technology, other more complex data encoding formats have become as common as the PCM format. These formats are frequently referred to as non-PCM formats. Often the data is encoded in a compressed format, for example with a variable compression factor depending on the data content and/or on the required quality. A data-encoding format that includes compressed data also includes metadata which contains indications for de-compression of the compressed data. Compressed audio data streams frequently comprise a sequence of frames. A frame of compressed data can be uncompressed into a PCM audio stream of known duration. Metadata associated with a frame of audio data is termed “header” by virtue of it (usually) preceding the compressed data payload. Handling data in a compressed format offers a plurality of advantages. Due to its reduced size, it requires less storage space, less bandwidth for communication and offers other advantages. An AC3 data format is an example of a compressed data format.

An I2S communication link is a serial communication link. The I2S link communicates data encoded according to the PCM format. This link offers a cheap and an efficient means for communicating digital audio signals. Therefore, it has acquired a wide acceptance in the industry. However, in spite of being cheap and widely available, the I2S link or similar links are not preferred for communicating a data stream encoded according to the non-PCM data format; the format that offers a plurality of advantages over the PCM data format. This is because the I2S link transmits data sample-by-sample (sample size typically 24 bits) and does not have the facilities to include the metadata or to distinguish between the PCM and the non-PCM formats of data encoding. In order to communicate a data stream encoded according to the non-PCM format via a link intended for PCM-formatted data, such as an I2S link, a dedicated interface is required. The interface distinctly identifies the non-PCM data format and allows inclusion of the metadata for communication, thereby facilitating communication of both the PCM and the non-PCM data format.

The Standard IEC 60958 defines an audio interface as one that enables communication of a data stream encoded according to the non-PCM format through the I2S link.

For communicating data using this interface, the IEC 60958 Standard defines frames as a plurality of samples. In a sample the interface reserves an identified number of bits for inclusion of a metadata or a part of metadata. According to one example the sample size is defined (typically) as 32 bits. Out of 32-bits 8 bits are reserved for including metadata. For communicating a data sample encoded according to a PCM format using an I2S link having this interface requires supplying of a padding element instead of metadata, as there is no need to send any additional information with PCM data format. Change in the sample size used by the I2S link requires a substantial up-grading in the protocol environment of the I2S link.

Further for communicating non-PCM encoded data, (e.g. data encoded according to AC3 format) this interface receives a frame of data encoded according to a non-PCM format. The frame includes a metadata portion (header) and a data portion. The interface identifies the metadata (header) and spreads it over the reserved bits (8-bits) of a plurality of samples. The interface further spreads the data portion of the frame over a plurality of samples, thereby scattering the received frame over a plurality of samples. A frame of the IEC 60958 interface is defined as a set of samples, said set having a number of samples that are required to fit both the metadata portion and the data portion of the received frame. At the receiving end, the interface provides means for assembling the data back in the original format.

Thus the IEC 60958 interface requires a means for disassembling the data stream at the source end of the I2S link, which decodes the data stream according to the header/metadata associated with individual frames (and/or subframes) and packs it as described above for communicating it over the link. Further, the interface provides a corresponding reassembling means at the receiving-end of the communication link for putting the disassembled data back in the original format. These scatter-gather (disassembling-assembling) functions at bitfield level involve extensive computational resources for both hardware and software realizations. Additionally, computational resource with a communication link only for the purpose of communicating data streams is expensive.

WO patent application PCT/IB96/01267 describes a burst format of the MPEG encoded audio for transfer via the IEC 60958 transmission system, which uses a same frame sampling rate and contains the same number of data bits in a frame as I2S link.

Therefore, from the above discussion, it is clear that it is advantageous to have a method and device that allows communications of data encoded according to a non-PCM format through a communication link that is designed for communicating data encoded according to a PCM format.

To this end, in accordance with certain aspects of the invention a method is provided comprising the steps of: packing a first data stream into a second data stream, said first data stream having a plurality of data-packets and being encoded according to a non-PCM format, wherein a first number of data elements of each data-packet of the second data stream represent a discontinuity in a PCM format, and; communicating the second data stream via a communication link designed for communicating a data stream that is encoded according to said PCM format. The method further provides the steps of: receiving the second data stream via the communication link, and; identifying the second data stream by examining for the discontinuity.

This embodiment of the method according to the invention uses the fact that a data stream typically encoded according to a PCM format does not include a discontinuity. Therefore, an introduction of a discontinuity at an identified location can distinctly identify the data stream as a data stream encoded according to a non-PCM format. Introduction of the discontinuity may be achieved by software code without requiring substantial alteration in hardware. This provides flexibility to maintain the hardware specification of the link in accordance with the standard specification, and therefore the link can be used for communicating data stream encoded according to the PCM format as usual (without requiring any up-grading). In addition the method is advantageous because it does not require alteration of (assembling-disassembling) the standard format of the non-PCM data stream at a bitfield level. This is because the discontinuity is created by introducing additional data elements between two consecutive data-packets. The content of the data packets need not be changed. At the receiving end a PCM or a non-PCM data string may be identified by detecting a discontinuity. This detection can be performed using a software although dedicated hardware may be applied if desired. Furthermore, as the data stream is communicated over the link without any bitfield level alteration, the only requirement is to provide a software code at the receiving end of the link for completely or partially ignoring the data elements that represent the discontinuity. Consequently the inventive method allows communication of data encoded according to the non-PCM format over a communication link that is designed for communicating data encoded according to a PCM format.

According to one embodiment of the invention the method may be used for packing and communicating a first data stream encoded according to the AC3 compressed audio data format into a second data stream for communicating the second data stream over a link designed for communicating a PCM data format. The data-packets in this embodiment may be the frames as defined for the AC3 format.

According to an embodiment of the method according to the invention each data-packet of the second data stream may start with one or more header elements and may end with one or more padding elements. In this embodiment the second data-stream comprises at least a first data-packet and at least one subsequent data-packet. The first number of data elements of the subsequent data-packet represents the discontinuity in conjunction with the last number of data elements of the preceding data-packet. The first data-packet of the second data stream is supplied with one or more header elements and end with one or more padding elements and wherein a combination of the padding elements of a data-packet and header elements of an immediately following data-packet represents a discontinuity in the PCM format and the method further comprising the step of supplying the first data-packet of the second data stream with additional header elements preceding the header elements, which additional header elements have the same value as the padding elements, wherein the additional header elements together with the immediately following header elements of the first data-packet represent a discontinuity in a PCM format.

The non-PCM formats, particularly compressed formats provide a data stream that includes data-packets, wherein each data-packet includes a header element that represent information relating to data contained in the data-packet. Furthermore according to a specific example of a data format defined in the IEC 61937 standard the data-packets include header elements as well as padding elements. The header elements of a data-packet when read in conjunction with the padding elements of preceding data-packet represent a discontinuity according to PCM format. This header and padding elements may be re-used to represent the discontinuity. In this way the overhead in the second data stream is restricted to a minimum, as the data elements present in the first data streams are re-used to represent a discontinuity.

In an example of packing, the first data stream is encoded according to the AC3 data format. The first data stream comprises a plurality of data-packets. Each of the data-packets may be provided with one or more sync words (refer definition 2) as starting elements and one or more padding elements as ending elements of the data-packets. The data-packet in this case may be a frame of the data stream encoded according to the AC3 format.

The first data-packet of the second data stream is supplied with one ore more additional header elements preceding the header elements, which additional header elements have the same value as the padding elements, wherein the additional header elements together with the immediately following header elements of the first data-packet represent a discontinuity in a PCM format, thereby packing the first data stream into a second data stream. The second data stream is then communicated through a communication link designed for communicating a data stream encoded according to a PCM format.

According to another example, a first compressed data stream encoded according to the format described in Standard IEC 61937 may be packed into a second data stream. According to this example, the packed data-packet is a frame as defined in the Standard IEC61937. The first data stream includes padding elements (“0” padding) at the end of each frame/subframe, and has a sync word at the beginning of each frame/subframe. The sync word includes Pa and Pb. The word Pa represents a value “F872h” and the word Pb represents the value “4E1Fh”. A combination of the words Pa and Pb together with the padding elements of directly preceding data packet represents a discontinuity according to the PCM format. The first data-packet of the second data stream is supplied with one ore more additional header elements preceding the header elements, which additional header elements have the same value as the padding elements, wherein the additional header elements together with the immediately following header elements of the first data-packet represent a discontinuity in a PCM format, thereby packing the first data stream into a second data stream. The second data stream is then communicated through a communication link designed for communicating a data stream encoded according to a PCM format. The second data stream including the discontinuity at the boundary between each pair of subframes/frames is communicated through a link designed for communicating a data stream encoded according to the PCM format.

The present invention further provides for a device comprising an input for receiving a first data stream encoded according to a non-PCM format, said first data stream having a plurality of data-packets; a communication link designed for communicating a data stream that is encoded according to a PCM format; and, a packing unit for packing the first data stream into a second data stream, said packing unit being arranged for providing the second data stream to communicate it via the communication link, wherein a first number of data elements of each data-packet of the second data stream represents a discontinuity according to a PCM format. The device further provides a receiver for receiving the second data stream via the communication link, and; an identifying unit for identifying the received data stream by examining for the discontinuity.

The device may be implemented using hardware or software code or a combination thereof. The packing unit of the device allows supplying of data elements for packing a first data stream into a second data stream. Programmable delays or registers may supply data elements. The data elements that are required to be included with the data streams may be included with the data stream by selectively passing the first data stream through delays elements. The delay elements may be programmed for supplying zeroes or ones or any combination thereof for including a discontinuity according above discussion. The delays may be implemented using inverters or buffers. The registers may be implemented using logic gates.

At the receiving end the discontinuity is identified and accordingly it is determined that the data stream communicated is a non-PCM data stream. For identifying the discontinuity and therewith the format of the data stream, the identifying unit may be provided with comparator/s, or logic gate/s or a combination thereof. The output of the identifying unit may enable routing of the data stream according to the identified data format.

These and further aspects and advantages of a method and a device according to the present invention will be now discussed in more detail hereinafter with reference to enclosed drawings, therein;

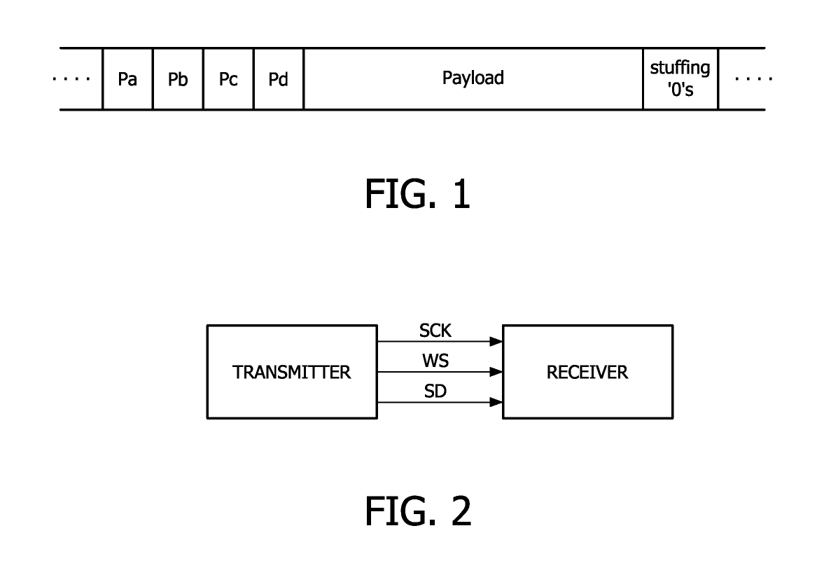

FIGS. 1 illustrates a data format according to the IEC 61937 standard;

FIG. 2 illustrates a I2S communication link;

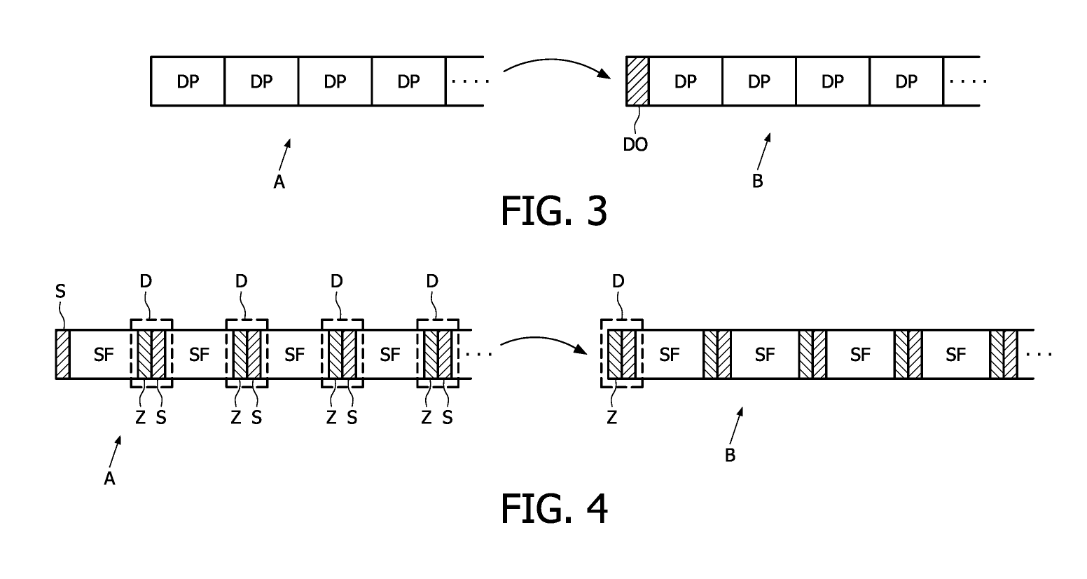

FIGS. 3-6 various embodiments of the steps followed for executing a method for data packing, and;

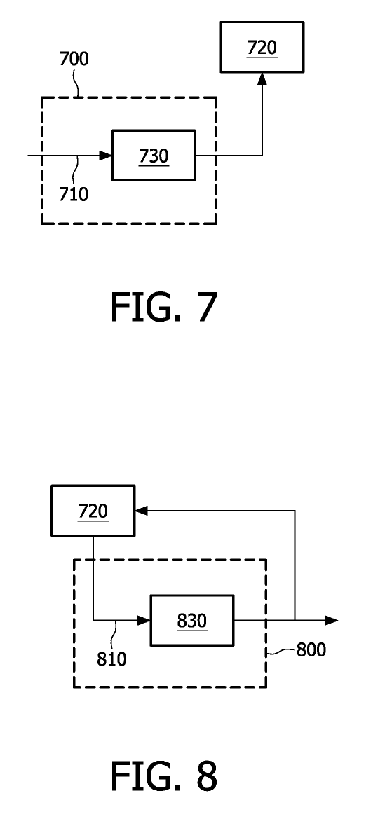

FIGS. 7-8 shows a device for implementing the method.

For a better understanding of the method and the device, the I2S link and the format according to the IEC 61937 standards are briefly described.

FIG. 1 shows a burst format of a data stream described in the IEC 61937 Standard. For a detailed description of the burst format, reference is made to clause 6 of IEC 61937 document 100/260/FDIS. A relevant description of the data encoding format according to the standard IEC 61937 is being presented herewith.

The burst format shown in FIG. 1, has four preamble words Pa, Pb, Pc and Pd, with following meanings: Pa and Pb represent a synchronization word (sync words), Pc represents information about the type of data and information/control for the receiver, Pd represents the length of the payload in bits. The burst contains a payload field and is terminated by stuffing zeroes (padding elements) to attain its pre-specified format.

Table 1 summarizes preamble words and their corresponding contents, and the value contained therein.

TABLE 1
Burst-preamble words

| Preamble | Contents | Value MSB . . . LSB |
|---|---|---|
| Pa | Sync word 1 | F872h |
| Pb | Sync word 2 | 4E1Fh |
| Pc | Burst-info | ** |
| Pd | Length-code | Number of bits |

** Refer to Table 5 of IEC 61937 document 100/260/FDIS presented on Page 23.

Note that the Preamble words Pa, Pb are fixed and follow a fixed order. Further note that the value of the preamble word Pa corresponds to F872h and the value of the preamble word Pb corresponds to 4EIFh.

FIG. 2 shows an I2S link. The I2S link has a transmitter and a receiver(s) both connected via three signal lines: a clock signal (SCK), a word-select signal (WS) and a serial data signal (SD) line. The data is serially transferred from the transmitter to the receiver(s) via the serial data line, in synchronisation with periodic clock pulses of the clock signal. The transmitter and the receiver(s) are synchronised to the same clock signal.

FIG. 3 shows an embodiment for implementing a method according to the present invention. According to the method a first data stream A encoded according to a non-PCM format and having a plurality of data-packets DP, is packed into a second data stream B by introducing one or more data elements that represent a discontinuity DO in a PCM format at the first data-packet of the first data stream A. The second data stream B is then communicated via a communication link designed for communicating a data stream that is encoded according to said PCM format.

This embodiment is further explained with reference to FIG. 4 showing a first and a second data stream A, B. According to this example the first data stream A encoded according to the format described in the IEC 61937 is packed into the second data stream B. The sync word includes Pa, Pb, Pc, Pd. The words Pa and Pb represent a value “F872h” and the word Pb represents the value “4E1Fh”. When the words Pa and Pb are read together with the padding elements, this combination represents a discontinuity D according to the PCM format. In a step the method supplies a number of padding elements Z as the first elements of the first subframe of the data stream A to provide the second data stream B. The supplied padding elements together with the sync word S of the first subframe represent the discontinuity D according to the PCM format. Thereby including the discontinuity D with each subframe SF. The second data stream B is then communicated via a communication link designed for communicating a data stream that is encoded according to said PCM format.

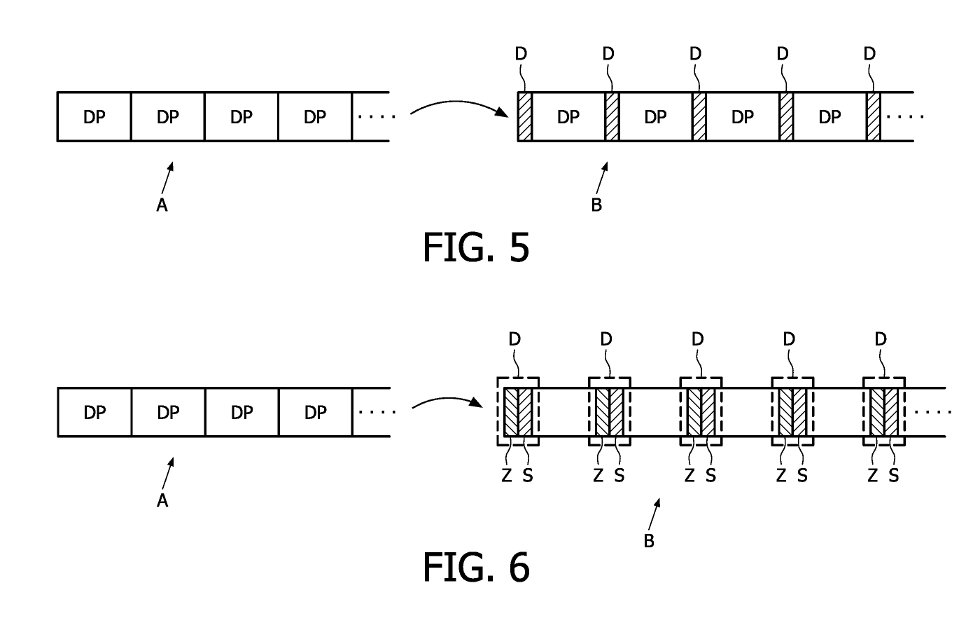

FIG. 5 shows another embodiment for implementing a method according to the present invention. According to the method a first data stream A that is encoded according to a non-PCM format and has a plurality of data-packets DP, is packed into a second data stream B by introducing one or more data elements that represent a discontinuity D in the PCM format with each data-packet of the first data stream A. The discontinuity D may be introduced by supplying a set of elements that represent a discontinuity according to the PCM format at the starting of each data packet DP, as shown in FIG. 5. The second data stream B is then communicated via a communication link designed for communicating a data stream that is encoded according to said PCM format.

FIG. 6 shows another embodiment of the method for packing and communicating a first data stream A into a second data stream B. In this embodiment a discontinuity D according to the PCM format may be introduced by supplying each of the data-packets DP with one or more padding elements Z at the end of each data-packet DP and one ore more sync words (refer disclaimer 3) S as starting elements of each data-packet. The padding elements Z of a data-packet DP together with the sync word S of the immediately following data-packet represent the discontinuity D. The first data-packet is provided with the padding elements Z at the beginning of the data-packet to represent the discontinuity together with the sync word S of the first data-packet. Thereby including the discontinuity with each data-packet DP. The second data stream B is then communicated via a communication link designed for communicating a data stream that is encoded according to said PCM format.

In a case the data packet has a header. In this case one or more starting elements of the header may represent the sync word S. Thereby avoiding the need for supplying a sync word.

In an implementation of this method the data packet comprises a frame defined according to the AC3 data format. According to one embodiment the header elements/sync-word are the first number of elements of the header defined according to the AC3 data format. The padding elements may be supplied according to the method. With above definitions the data encoded according to the AC3 format may be packed and communicated through a communication link designed for communicating a PCM format when implemented in any one of the embodiments discussed with reference to FIGS. 3 to 6.

The present invention provides for a method for receiving the second data stream via the communication link as discussed in FIGS. 3-6 and identifying said second stream by examining for a discontinuity.

FIG. 7 shows a device 700 for implementing the method discussed above. The device 700 has an input 710 for receiving a first data stream encoded according to a non-PCM format. The first data stream has a plurality of data-packets. The output of the device is connected to a communication link 720 designed for communicating a data stream that is encoded according to a PCM format. Further the device 700 has a packing unit 730 that receives the input 710 and packs the first data stream into a second data stream and supplies the second data stream to the communication link. A first number of data elements of each data-packet of the second data stream represents a discontinuity according to a PCM format. The second data-stream comprises at least a first data-packet and at least one subsequent data-packet. The first number of data elements of the subsequent data-packet represents the discontinuity in conjunction with the last number of data elements of the preceding data-packet. The packing unit 730 of the device 700 may be provided with programmable delays or registers for supplying data elements. The delays may be implemented using inverters or buffers. The registers may be implemented using logic gates. The data elements that are required to be included in the second data streams may be selectively passed through delay elements. The delay elements may be programmed for supplying zeroes or ones or any combination thereof for creating a discontinuity in accordance with the above discussion. The data elements added to the stream may represent a discontinuity either autonomously, or in conjunction with the data elements provided with the first data stream.

FIG. 8 shows a device 800 having a receiver 810 for receiving the second data stream via the communication link 720. The receiver 810 has an identifying unit 830 for identifying the received data stream by examining for the discontinuity supplied by the packing unit 730. The identifying unit 830 may be provided with comparator/s, or logic gate/s or a combination thereof for identifying the discontinuity. The output of the identifying unit 830 may connected to the link 720 for enabling routing of the data stream according to the identified data format. Further the output may also be provided to other units that may require information regarding the format of the communicated data stream.

The order in the described embodiments of the method and device of according to the invention is not mandatory, and is illustrative only. The scope of the present invention is not limited to the described embodiments. A person skilled in the art may change the order of steps or perform steps concurrently using threading models, multi-processor systems or multiple processes without departing from the concept as intended by the present invention. Any such embodiment will fall under the scope of the present invention and is a subject matter of protection. It should be noted that the above-mentioned embodiments illustrate rather than limit the method and device, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The method and device can be implemented by means of hardware comprising several distinct elements, and by means of a suitably programmed computer. In the device claims enumerating several means, several of these means can be embodied by one and the same item of computer readable software or hardware. The mere fact that certain measures are recited in mutually different dependent claims does not indicate that a combination of these measures cannot be used to advantage.

1. A method comprising the steps of:
packing a first data stream into a second data stream, said first data stream having a plurality of data-packets and being encoded according to a non-PCM format, wherein a first number of data elements of each data-packet of the second data stream represent a discontinuity in a PCM format, and;
communicating the second data stream via a communication link designed for communicating a data stream that is encoded according to said PCM format.

2. The method according to claim 1 wherein the second data-stream comprises at least a first data-packet and at least one subsequent data-packet and wherein the first number of data elements of the subsequent data-packet represents the discontinuity in conjunction with the last number of data elements of the preceding data-packet.

3. The method according to claim 1 wherein said data-packets of the second data stream start with one or more header elements and end with one or more padding elements and wherein a combination of the padding elements of a data-packet and header elements of an immediately following data-packet represents a discontinuity in the PCM format and the method further comprising the step of supplying the first data-packet of the second data stream with additional header elements preceding the header elements, which additional header elements have the same value as the padding elements, wherein the additional header elements together with the immediately following header elements of the first data-packet represent a discontinuity in a PCM format.

4. The method according to claim 1 wherein said first data stream includes a compressed data stream.

5. The method according to claim 1 wherein the method further comprises the steps of:
receiving the second data stream via the communication link, and;
identifying the second data stream by examining for the discontinuity.

6. A device comprising:
an input for receiving a first data stream encoded according to a non-PCM format, said first data stream having a plurality of data-packets;
a communication link designed for communicating a data stream that is encoded according to a PCM format; and,
a packing unit for packing the first data stream into a second data stream, said packing unit being arranged to provide the second data stream for communication via the communication link, wherein a first number of data elements of each data-packet of the second data stream represents a discontinuity according to a PCM format.

7. The device according to claim 6 wherein the second data-stream comprises at least a first data-packet and at least one subsequent data-packet and wherein the first number of data elements of the subsequent data-packet represents the discontinuity in conjunction with the last number of data elements of the preceding data-packet.

8. The device according to claim 6 wherein said data-packets of the second data stream start with one or more header elements and end with one or more padding elements, wherein a combination of the padding elements of a data-packet and the header elements of an immediately following data-packet represents a discontinuity in the PCM format and the first data-packet of the second data stream is supplied with padding elements as starting elements, wherein the supplied padding elements together with the header elements of the first data-packet represent a discontinuity in a PCM format.

9. The device according to claim 6 wherein said first data stream includes compressed data.

10. The device according to claim 6 further comprising:
a receiver for receiving the second data stream via the communication link, and;
an identifying unit for identifying the received data stream by examining for the discontinuity.
